(19) United States
(12) Patent Application Publication
(10) Pub. No.: US 2016/0146605 A1
(43) Pub. Date: May 26, 2016

(54) GYRO SENSOR, ELECTRONIC APPARATUS, AND MOVING BODY

(71) Applicant: Seiko Epson Corporation, Tokyo (JP)

(72) Inventor: Makoto FURUHATA, Matsumoto (JP)

(21) Appl. No.: 14/947,227

(22) Filed: Nov. 20, 2015

(30) Foreign Application Priority Data
Nov. 25, 2014 (JP) 2014-237405

(51) Int. Cl. G01C 19/5712

(52) U.S. Cl. CPC G01C 19/5712

(57) ABSTRACT

A gyro sensor includes a substrate, a first vibrating body and a second vibrating body, first suspension springs that support the first vibrating body, second suspension springs that support the second vibrating body, and a connection spring that connects the first vibrating body and the second vibrating body. When a spring constant of the first suspension springs and the second suspension springs is K1 and a spring constant of the connection spring is K2, 2K2≦K1 is satisfied.

### BACKGROUND

1. Technical Field

The present invention relates to a gyro sensor, an electronic apparatus, and a moving body.

2. Related Art

In recent years, an inertia sensor for detecting physical quantities by using a silicon micro electro mechanical system (MEMS) technique has been developed. In particular, for example, in a gyro sensor for detecting an angular velocity, applications of a shake correcting function of a digital still camera (DSC), a navigation system of an automobile and a motion sensing function of a game machine, and the like have been rapidly expanded.

As such a gyro sensor, for example, a structure, in which two vibration mass bodies are mechanically coupled through a connection range formed of a connection mass body and a vibration spring so as to be driven to vibrate in opposite phase to each other, is disclosed in Japanese Patent No. 4047377. In the gyro sensor in Japanese Patent No. 4047377, it is possible to separate a natural frequency of an opposite phase mode and a natural frequency of an in-phase mode, and to generate a stable positional relationship in two vibration mass bodies.

However, in the gyro sensor of Japanese Patent No. 4047377, since the vibration spring for coupling the two vibration mass bodies is hard and a suspension spring (suspended spring) supporting the vibration mass bodies is soft, there is a problem that quadrature is likely to occur.

Here, quadrature is described. The drive vibration of the vibration mass body is ideally perpendicular to a detection direction and the vibration mass body is not displaced in the detection direction as long as an angular velocity is not input. However, a displacement component in the detection direction occurs in some cases (unnecessary vibration leakage) when the vibration mass body is driven to vibrate by the asymmetry of the structure and the like that occur in a manufacturing process. This is referred to as quadrature.

In the gyro sensor of Japanese Patent No. 4047377, as described above, the suspension spring supporting the vibration mass bodies is soft, and the vibration mass bodies are likely to be displaced in a direction (detection direction) perpendicular to a vibration plane by the influence of quadrature. Furthermore, in the gyro sensor of Japanese Patent No. 4047377, since the vibration spring for coupling two vibration mass bodies is hard, vibration caused by quadrature that occurs in one vibration mass body may affect the other vibration mass body in some cases.

### SUMMARY

An advantage of some aspects of the invention is that a gyro sensor is provided in which the influence of quadrature can be reduced and a natural frequency of an opposite phase mode and a natural frequency of an in-phase mode can be separated. Furthermore, another advantage of some aspects of the invention is that an electronic apparatus and a moving body including the gyro sensor described above are provided.

The invention can be realized in the following aspects or application examples.

### Application Example 1

According to this application example, there is provided a gyro sensor including a substrate; a first vibrating body and a second vibrating body; first suspension springs that support the first vibrating body; second suspension springs that support the second vibrating body; and a connection spring that connects the first vibrating body and the second vibrating body, in which when a spring constant of the first suspension springs and the second suspension springs is K1, and a spring constant of the connection spring is K2, 2K2≦K1 is satisfied.

In such a gyro sensor, the spring constant K1 of the first suspension spring and the second suspension spring and the spring constant K2 of the connection spring satisfy 2K2≦K1. That is, the connection spring is softer than the first suspension springs and the second suspension springs, or has the same softness as the first suspension springs and the second suspension springs. Thus, in such a gyro sensor, for example, it is possible to reduce displacement of the vibrating body in a detection direction due to the influence of quadrature compared to a case where the connection spring is harder than the first suspension springs and the second suspension springs.

Furthermore, in such a gyro sensor, for example, it is possible to reduce the influence of vibration due to the influence of quadrature generated by one vibrating body (first vibrating body) on the other vibrating body (second vibrating body) compared to a case where the connection spring is harder than the first suspension springs and the second suspension springs. Thus, in such a gyro sensor, it is possible to reduce the influence of quadrature.

Furthermore, in such a gyro sensor, as described below, it is possible to separate a natural frequency of an opposite phase mode and a natural frequency of an in-phase mode. Thus, it is possible to reduce the influence of the in-phase mode with respect to a vibration mode (the opposite phase mode) of a vibration system.

### Application Example 2

In the gyro sensor according to the application example described above, the first suspension springs may support the first vibrating body at four points, the second suspension springs may support the second vibrating body at four points, and the first suspension springs and the second suspension springs may be independent.

In such a gyro sensor, it is possible to reduce the influence of the quadrature and to separate the natural frequency of the opposite phase mode and the natural frequency of the in-phase mode.

### Application Example 3

In the gyro sensor according to the application examples described above, one end of the connection spring may be connected to the first vibrating body and the other end of the connection spring may be connected to the second vibrating body

In such a gyro sensor, it is possible to reduce the influence of the quadrature and to separate the natural frequency of the opposite phase mode and the natural frequency of the in-phase mode.

### Application Example 4

In the gyro sensor according to the application examples described above, the first vibrating body and the second vibrating body may be driven to vibrate in opposite phase to each other.

In such a gyro sensor, it is possible to separate the natural frequency of the opposite phase mode and the natural frequency of the in-phase mode. Thus, it is possible to reduce the influence of the in-phase mode with respect to the vibration mode (opposite phase mode) of the vibration system.

### Application Example 5

In the gyro sensor according to the application examples described above, the spring constant K1 of the first suspension springs and the second suspension springs, and the spring constant K2 of the connection spring may be the spring constants in a direction of drive vibration of the first vibrating body and the second vibrating body.

In such a gyro sensor, it is possible to reduce the influence of the quadrature and to separate the natural frequency of the opposite phase mode and the natural frequency of the in-phase mode.

### Application Example 6

According to this application example, there is provided an electronic apparatus including the gyro sensor according to the application examples.

In such an electronic apparatus, the gyro sensor can be provided which can reduce the influence of the quadrature and separate the natural frequency of the opposite phase mode and the natural frequency of the in-phase mode.

### Application Example 7

According to this application example, there is provided a moving body including the gyro sensor according to the application example.

In such a moving body, the gyro sensor can be provided which can reduce the influence of the quadrature and separate the natural frequency of the opposite phase mode and the natural frequency of the in-phase mode.

### BRIEF DESCRIPTION OF THE DRAWINGS

The invention will be described with reference to the accompanying drawings, wherein like numbers reference like elements.

FIG. 1 is a plan view schematically illustrating a gyro sensor according to a first embodiment.

FIG. 2 is a sectional view schematically illustrating the gyro sensor according to the first embodiment.

FIG. 3 is a view modeling a mechanical structure of the gyro sensor according to the first embodiment.

FIG. 4 is a flowchart illustrating an example of a manufacturing method of the gyro sensor of the first embodiment.

FIG. 5 is a sectional view schematically illustrating a manufacturing step of the gyro sensor according to the first embodiment.

FIG. 6 is a sectional view schematically illustrating the manufacturing step of the gyro sensor according to the first embodiment.

FIG. 7 is a view illustrating the gyro sensor of a model of simulation of an example.

FIG. 8 is a view illustrating a gyro sensor of a model of simulation of a comparison example.

FIG. 9 is a plan view schematically illustrating a gyro sensor according to a second embodiment.

FIG. 10 is a sectional view schematically illustrating the gyro sensor according to the second embodiment.

FIG. 11 is a view illustrating the gyro sensor of a model of simulation of an example.

FIG. 12 is a view illustrating a gyro sensor of a model of simulation of a comparison example.

FIG. 13 is a block diagram illustrating a function of an electronic apparatus according to a third embodiment.

FIG. 14 is a view illustrating the appearance of a smart phone that is an example of the electronic apparatus of the third embodiment.

FIG. 15 is a view illustrating an appearance of a wearable apparatus that is an example of the electronic apparatus of the third embodiment.

FIG. 16 is a perspective view schematically illustrating a moving body according to a fourth embodiment.

### DESCRIPTION OF EXEMPLARY EMBODIMENTS

Hereinafter, preferable embodiments of the invention will be described with reference to the drawings. Moreover, the embodiments described below do not unduly limit the content of the invention described in the aspects. In addition, all of the structures described below are not essential structure requirements of the invention.

### 1. First Embodiment

### 1.1. Gyro Sensor

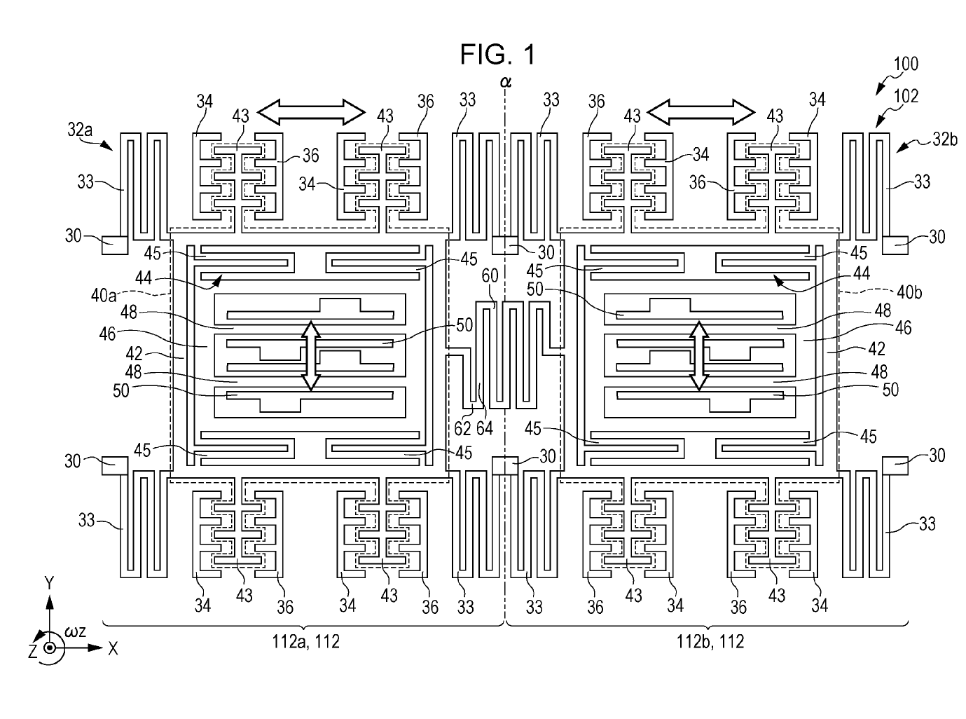

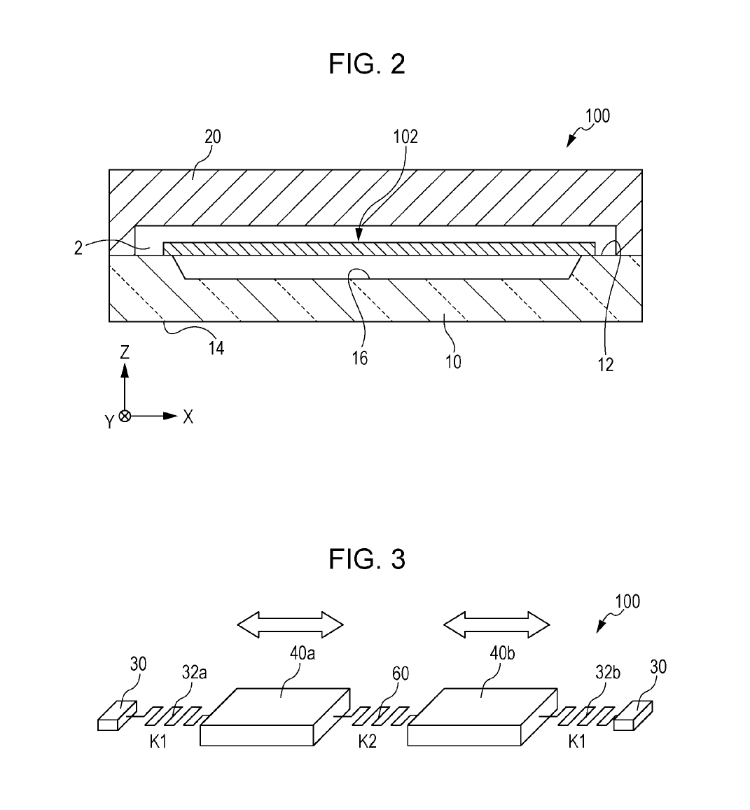

First, a gyro sensor according to a first embodiment will be described with reference to the drawings. FIG. 1 is a plan view schematically illustrating a gyro sensor 100 according to the first embodiment. FIG. 2 is a sectional view schematically illustrating the gyro sensor 100 according to the first embodiment. Moreover, in FIGS. 1 and 2, as three axes orthogonal to each other, an X axis, a Y axis, and a Z axis are illustrated.

As illustrated in FIGS. 1 and 2, the gyro sensor 100 includes a substrate 10, a lid 20, and a functional element 102. Moreover, for the sake of convenience, the substrate 10 and the lid 20 are omitted in FIG. 1. Furthermore, the functional element 102 is simplified in FIG. 2. The gyro sensor 100 is a gyro sensor detecting an angular velocity ωz around the Z axis.

The material of the substrate 10 is, for example, glass. The material of the substrate 10 may be silicon. As illustrated in FIG. 2, the substrate 10 has a first surface 12 and a second surface 14 that is opposite (directed in a direction opposite to the first surface 12) to the first surface 12. A concave section 16 is formed in the first surface 12 and vibrating bodies 40a and 40b are disposed above (+Z axis direction side) the concave section 16. The concave section 16 forms a cavity 2.

The lid 20 is provided on the substrate 10 (+Z axis direction side). A material of the lid 20 is, for example, silicon. The lid 20 is bonded to the first surface 12 of the substrate 10. The substrate 10 and the lid 20 may be bonded by anodic bonding. In the illustrated example, a concave section is formed in the lid 20 and the concave section forms the cavity 2.

Moreover, a bonding method between the substrate 10 and the lid 20 is not specifically limited and, for example, bonding may be performed with low melting-point glass (glass paste) or may be performed by soldering. Alternatively, a metal thin film (not illustrated) is formed in each bonding portion of the substrate 10 and the lid 20, and the substrate 10 and the lid 20 may be bonded by causing eutectic bonding between the metal thin films.

The functional element 102 is provided on the first surface 12 side of the substrate 10. The functional element 102 is bonded to the substrate 10, for example, by anodic bonding or direct bonding. The functional element 102 is accommodated in the cavity 2 that is formed by the substrate 10 and the lid 20. The cavity 2 is preferably in a reduced pressure state. Thus, it is possible to suppress attenuation of vibration of the vibrating bodies 40a and 40b by air viscosity.

As illustrated in FIG. 1, the functional element 102 has two structures 112 (first structure 112a and second structure 112b) and a connection spring 60 connecting the two structures 112. The two structures 112 are provided side by side in an X axis direction so as to be symmetrical with respect to an axis α parallel to the Y axis.

First, the first structure 112a will be described.

The first structure 112a has fixed sections 30, first suspension springs 32a, fixed driving electrode sections 34 and 36, a first vibrating body 40a, and fixed detection electrode sections 50. The first suspension springs 32a and the first vibrating body 40a are provided above the concave section 16 and are separated from the substrate 10.

The fixed sections 30 are fixed to the substrate 10. The fixed sections 30 are bonded to the first surface 12 of the substrate 10, for example, by anodic bonding. For example, four fixed sections 30 are provided in the first structure 112a. In the illustrated example, the fixed sections 30 on the +X axis direction side of the first structure 112a and the fixed sections 30 on the −X axis direction side of the second structure 112b are common fixed sections. Moreover, the fixed sections 30 on the +X axis direction side of the first structure 112a and the fixed sections 30 on the −X axis direction side of the second structure 112b may be independent fixed sections respectively.

The first suspension springs 32a connect the fixed sections 30 and a vibration section 42 of the first vibrating body 40a. The first suspension springs 32a are each formed of a plurality of beam sections 33. The beam sections 33 have a meandering shape extending in the X axis direction while reciprocating in a Y axis direction. The plurality of beam sections 33 are provided in a number corresponding to the number of the fixed sections 30. In the illustrated example, four beam sections 33 are provided corresponding to four fixed sections 30. That is, the first suspension springs 32a support the first vibrating body 40a at four points. The beam sections 33 forming the first suspension spring 32a can be smoothly expanded and contracted in the X axis direction that is a direction of the drive vibration of the first vibrating body 40a.

The fixed driving electrode sections 34 and 36 are fixed to the substrate 10. The fixed driving electrode sections 34 and 36 are bonded to the first surface 12 of the substrate 10, for example, by anodic bonding. The fixed driving electrode sections 34 and 36 are provided to face movable driving electrode sections 43, and the movable driving electrode sections 43 are disposed between the fixed driving electrode sections 34 and 36. As illustrated in FIG. 1, if the movable driving electrode sections 43 have a comb teeth shape, the fixed driving electrode sections 34 and 36 may have the comb teeth shape corresponding to the movable driving electrode sections 43.

The first vibrating body 40a has the vibration section 42, the movable driving electrode sections 43, a detection spring 44, a movable section 46, and movable detection electrode sections 48. The first vibrating body 40a is supported and vibrated in the X axis direction by the first suspension springs 32a.

The vibration section 42 is a rectangular frame body, for example, in plan view. A side surface (side surface parallel to the X axis and having a perpendicular line) of the vibration section 42 in the X axis direction is connected to the first suspension springs 32a. The vibration section 42 can be vibrated in the X axis direction (along the X axis) by the movable driving electrode sections 43 and the fixed driving electrode sections 34 and 36.

The movable driving electrode sections 43 are provided in the vibration section 42. In the illustrated example, four movable driving electrode sections 43 are provided, two movable driving electrode sections 43 are positioned on the +Y axis direction side of the vibration section 42 and the other two movable driving electrode sections 43 are positioned on the −Y axis direction side of the vibration section 42. As illustrated in FIG. 1, the movable driving electrode sections 43 may have the comb teeth shape including a main section extending from the vibration section 42 in the Y axis direction and a plurality of branch sections extending from the main section in the X axis direction.

The detection spring 44 connects the movable section 46 and the vibration section 42. The detection spring 44 is formed of a plurality of beam sections 45. In the illustrated example, the detection spring 44 is formed of four beam sections 45. That is, the detection spring 44 supports the movable section 46 at four points. The beam sections 45 have a meandering shape extending in the Y axis direction while reciprocating in an X axis direction. The beam sections 45 forming the detection spring 44 can be smoothly expanded and contracted in the Y axis direction that is the displacement direction of the movable section 46.

The movable section 46 is supported by the vibration section 42 through the detection spring 44. The movable section 46 is provided on the inside of the frame-shaped vibration section 42 in plan view. In the illustrated example, the movable section 46 is a rectangular frame shape in plan view. A side surface (side surface parallel to the Y axis and having a perpendicular line) of the movable section 46 in the Y axis direction is connected to the detection spring 44. The movable section 46 can be vibrated in the X axis direction according to the vibration of the vibration section 42 in the X axis direction.

The movable detection electrode sections 48 are provided in the movable section 46. The movable detection electrode sections 48 extend, for example, within the frame-shaped movable section 46 in the X axis direction. In the illustrated example, two movable detection electrode sections 48 are provided.

The fixed detection electrode sections 50 are fixed to the substrate 10 and are provided to face the movable detection electrode sections 48. The fixed detection electrode sections 50 are bonded to a post section (not illustrated) provided on a bottom surface (surface of the substrate 10 defining the concave section 16) of the concave section 16, for example, by anodic bonding. The post section protrudes up more than the bottom surface of the concave section 16. The fixed detection electrode sections are provided on the inside of the frame-shaped movable section 46 in plan view. In the illustrated example, the fixed detection electrode sections 50 are provided so as to sandwich the movable detection electrode sections 48.

Next, the second structure 112b will be described.

The second structure 112b has fixed sections 30, second suspension springs 32b, fixed driving electrode sections 34 and 36, a second vibrating body 40b, and fixed detection electrode sections 50. The second suspension springs 32b and the second vibrating body 40b are provided above the concave section 16 and are separated from the substrate 10.

In the second structure 112b, structures of the fixed sections 30, the fixed driving electrode sections 34 and 36, and the fixed detection electrode sections 50 are the same as those of the fixed sections 30, the fixed driving electrode sections 34 and 36, and the fixed detection electrode sections 50 of the first structure 112a described above, and description thereof will be omitted.

The second suspension springs 32b connect the fixed sections 30 and a vibration section 42 of the second vibrating body 40b. The second suspension springs 32b are each formed of a plurality of beam sections 33. The structure of the beam sections 33 is the same as the structure of the beam sections 33 of the first suspension spring 32a. The second suspension springs 32b support the second vibrating body 40b at four points. The second suspension springs 32b can be smoothly expanded and contracted in the X axis direction, which is the direction of the drive vibration of the second vibrating body 40b.

The first suspension springs 32a supporting the first vibrating body 40a and the second suspension springs 32b supporting the second vibrating body 40b are independent of each other. That is, each beam section 33 forming the first suspension spring 32a and each beam section 33 forming the second suspension spring 32b are not common. In the illustrated example, one end of each beam section 33 forming the first suspension spring 32a is fixed to the fixed section 30, the other end is connected to the first vibrating body 40a, and the beam sections 33 are not connected to another member such as the beam sections 33 forming the second suspension spring 32b. In addition, one end of each beam section 33 forming the second suspension spring 32b is fixed to the fixed section 30, the other end is connected to the second vibrating body 40b, and the beam sections 33 are not connected to another member such as the beam sections 33 forming the first suspension spring 32a.

The second vibrating body 40b has the vibration section 42, the movable driving electrode sections 43, a detection spring 44, a movable section 46, and movable detection electrode sections 48. The second vibrating body 40b is supported and vibrated in the X axis direction by the second suspension springs 32b. The structure of each of the sections 42, 43, 44, 46, and 48 forming the second vibrating body 40b is the same as the structure of each of the sections 42, 43, 44, 46, and 48 forming the first vibrating body 40a, and description thereof will be omitted.

The first vibrating body 40a and the second vibrating body 40b are driven to vibrate in opposite phase to each other. Here, the term “opposite phase” refers to a case where the two vibrating bodies 40a and 40b vibrate in opposite directions. Furthermore, an in phase refers to a case where the two vibrating bodies 40a and 40b vibrate in the same direction.

The connection spring 60 connects the first vibrating body 40a and the second vibrating body 40b. One end of the connection spring 60 is connected to the +X-axis-direction-side side surface of the vibration section 42 of the first vibrating body 40a and the other end of the connection spring 60 is connected to the −X-axis-direction-side side surface of the vibration section 42 of the second vibrating body 40b. The connection spring 60 is not connected to the substrate 10. That is, the connection spring 60 is not connected to the fixed section 30. Furthermore, the connection spring 60 is not connected to other members except the vibrating bodies 40a and 40b. The connection spring 60 is formed of, for example, one beam section. The connection spring 60 extends in the X axis direction while reciprocating in the Y axis direction. The connection spring 60 can be smoothly expanded and contracted in the X axis direction that is the direction of the drive vibration of the first vibrating body 40a and the second vibrating body 40b.

As illustrated in FIG. 1, for example, the connection spring 60 is formed of first extension sections extending in the X axis direction and second extension sections 64 extending in the Y axis direction. The connection spring 60 has a meandering shape that is formed of a plurality of first extension sections 62 and a plurality of second extension sections 64. As illustrated in FIG. 1, the connection section between the first extension section 62 and the second extension section 64 may be angular or may be round.

The fixed sections 30, the suspension springs 32a and 32b, the vibrating bodies 40a and 40b, and the connection spring 60 are integrally provided. The fixed section 30, the suspension springs 32a and 32b, the fixed driving electrode sections 34 and 36, the vibrating bodies 40a and 40b, the fixed detection electrode section 50, and the connection spring 60 are formed of silicon to which conductivity is given by doping the silicon with impurities such as phosphorus and boron. The functional element 102 is a silicon MEMS that is formed by processing a silicon substrate.

FIG. 3 is a view modeling a mechanical structure of the gyro sensor 100.

As illustrated in FIG. 3, the first vibrating body 40a and the second vibrating body 40b are respectively supported by the suspension springs 32a and 32b. The first suspension spring 32a supporting the first vibrating body 40a and the second suspension spring 32b supporting the second vibrating body 40b have the same spring constant in the direction of the drive vibration, that is, the X axis direction, and the spring constant of the suspension springs 32a and 32b is K1.

In FIG. 1, the first suspension spring 32a is formed of four beam sections 33 and the resultant spring constant of the spring constants k1 of the four beam sections 33 is the spring constant K1 of the first suspension spring 32a (in this example, K1=4k1). Furthermore, similarly, the resultant spring constant of the spring constants k1 of the four beam sections 33 of the second suspension spring 32b is the spring constant K1 of the second suspension spring 32b. Moreover, the spring constant of the first suspension spring 32a and the spring constant of the second suspension spring 32b may be different.

Furthermore, each of the first suspension spring 32a and the second suspension spring 32b may be formed of one, two, or three beam sections 33.

Furthermore, the first vibrating body 40a and the second vibrating body 40b are connected by the connection spring 60. The spring constant of the connection spring 60 in the X axis direction is K2.

In the gyro sensor 100, K1 and K2 satisfying 2K2≦K1 are set. That is, when assuming a case where the first vibrating body 40a and the second vibrating body 40b are driven to vibrate in the in-phase mode, the connection spring 60 has the spring constant K2 in the X axis direction and is a spring that is softer than the suspension springs 32a and 32b having the spring constant K1.

On the other hand, if the first vibrating body 40a and the second vibrating body 40b are driven to vibrate in opposite phase to each other, the midpoint of a length of the connection spring 60 in the X axis direction is the fixed point of the vibration. Thus, since the length of the connection spring 60 is half at the fixed point of the vibration, the spring constant of the connection spring 60 is 2K2. In the embodiment, if the drive vibrations are performed in the opposite phase mode, the spring constant of the connection spring 60 is 2K2K1 and the connection spring 60 is softer than the suspension springs 32a and 32b, but it may be assumed that the springs have the same stiffness. Thus, in the gyro sensor 100, the suspension springs 32a and 32b become a main factor for determining the frequency of the drive vibration of the vibrating bodies 40a and 40b.

Next, an operation of the gyro sensor 100 will be described.

When a voltage is applied between the movable driving electrode sections 43 and the fixed driving electrode sections 34 and 36 by a power supply (not illustrated), it is possible to generate an electrostatic force between the movable driving electrode sections 43 and the fixed driving electrode sections 34 and 36. Thus, it is possible to vibrate the vibrating bodies 40a and 40b in the X axis direction while expanding and contracting the suspension springs 32a and 32b, and the connection spring 60 in the X axis direction.

As illustrated in FIG. 1, in the first structure 112a, the fixed driving electrode sections 34 are disposed on the −X-axis-direction side of the movable driving electrode section 43 and the fixed driving electrode sections 36 are disposed on the +X-axis-direction side of the movable driving electrode section 43. In the second structure 112b, the fixed driving electrode sections 34 are each disposed on the +X-axis-direction side of the movable driving electrode section 43 and the fixed driving electrode sections 36 are each disposed on the −X-axis-direction side of the movable driving electrode section 43. Thus, a first alternating voltage is applied between the movable driving electrode section 43 and the fixed driving electrode sections 34, and a second alternating voltage of which a phase is shifted by 180 degrees from a phase of the first alternating voltage is applied between the movable driving electrode section 43 and the fixed driving electrode sections 36. Thus, it is possible to vibrate (vibrate in a tuning-fork manner) the first vibrating body 40a and the second vibrating body 40b in the X axis direction in opposite phase to each other and at a predetermined frequency.

In a state where the vibrating bodies 40a and 40b perform the vibration described above, when an angular velocity ωz about the Z axis is applied to the gyro sensor 100, a Coriolis force is generated, and the movable section 46 of the first vibrating body 40a and the movable section of the second vibrating body 40b are displaced in opposite directions in the Y axis direction (along the Y axis). The movable section 46 repeats the operation when receiving the Coriolis force.

The movable section 46 is displaced in the Y axis direction and then the distance between the movable detection electrode section 48 and the fixed detection electrode section 50 is changed. Thus, an electrostatic capacity between the movable detection electrode section 48 and the fixed detection electrode section 50 is changed. It is possible to obtain the angular velocity ωz about the Z axis by detecting the change in the amount of the electrostatic capacity between the electrode sections 48 and 50.

Moreover, in the above description, a system (electrostatic driving system) in which the vibrating bodies 40a and 40b are driven by the electrostatic force is described, but a method of driving the vibrating bodies 40a and 40b is not specifically limited and it is possible to apply a piezoelectric driving system, an electromagnetic driving system using a Lorentz force of a magnetic field, and the like.

For example, the gyro sensor 100 has the following features.

In the gyro sensor 100, when the spring constant of the first suspension spring 32a supporting the first vibrating body 40a and the second suspension spring 32b supporting the second vibrating body 40b is K1 and the spring constant of the connection spring 60 is K2, 2K2≦K1 is satisfied. That is, if the connection spring 60 is driven to vibrate in the in-phase mode, the connection spring 60 is softer than the suspension springs 32a and 32b, and if the connection spring 60 is driven to vibrate in the opposite phase mode, the connection spring 60 is softer than the suspension springs 32a and 32b, or has the same stiffness as the suspension springs 32a and 32b. Thus, in the gyro sensor 100, it is possible to reduce the displacement of the vibrating bodies 40a and 40b in the detection direction (Y axis direction) due to the influence of the quadrature compared to a case where the connection spring 60 is harder than the suspension springs 32a and 32b. Furthermore, in the gyro sensor 100, it is possible to reduce the influence of the vibration due to the influence of the quadrature generated by one vibrating body (for example, the first vibrating body 40a) on the other vibrating body (for example, the second vibrating body 40b) compared to a case where the connection spring 60 is harder than the suspension springs 32a and 32b. Therefore, in the gyro sensor 100, it is possible to reduce the influence of the quadrature.

Furthermore, in the gyro sensor 100, as described in “1.3. Example” below, it is possible to separate the natural frequency of the opposite phase mode and the natural frequency of the in-phase mode. Thus, in the gyro sensor 100, it is possible to reduce the influence of the in-phase mode with respect to the vibration mode (the opposite phase mode) of the vibration system and to improve sensor sensitivity.

Moreover, in the gyro sensor 100 described above, a case where the spring constant K1 of the suspension springs 32a and 32b and the spring constant K2 of the connection spring 60 satisfy 2K2≦K1 is described, but it may be 2K2<K1. That is, the connection spring 60 may be softer than the suspension springs 32a and 32b. Thus, similarly, it is possible to reduce the influence of the quadrature and to separate the natural frequency of the opposite phase mode and the natural frequency of the in-phase mode.

### 1.2. Method of Manufacturing Gyro Sensor

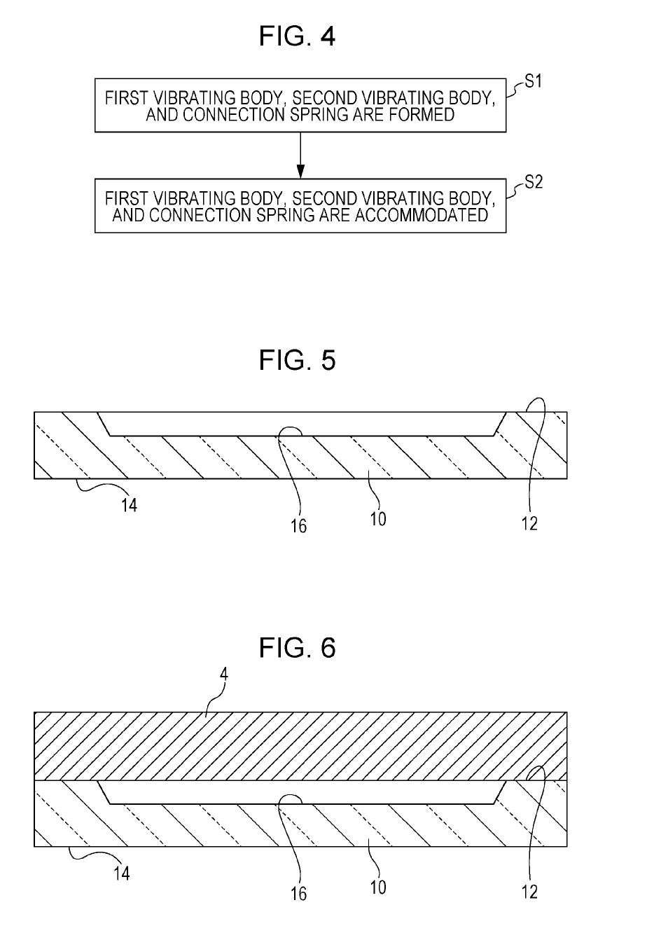

Next, a method of manufacturing the gyro sensor 100 according to the first embodiment will be described with reference to the drawings. FIG. 4 is a flowchart illustrating an example of the manufacturing method of the gyro sensor 100 of the first embodiment. FIGS. 5 and 6 are sectional views schematically illustrating manufacturing steps of the gyro sensor 100 according to the first embodiment.

The functional element 102 having the first vibrating body 40a, the second vibrating body 40b, and the connection spring 60 is formed (S1). Specifically, first, as illustrated in FIG. 5, a glass substrate is prepared and the concave section 16 is formed by patterning the glass substrate. Patterning is performed, for example, by photolithography and etching. It is possible to obtain the substrate 10 in which the concave section 16 is provided by this step.

As illustrated in FIG. 6, a silicon substrate 4 is bonded to the first surface 12 of the substrate 10. Bonding between the substrate 10 and the silicon substrate 4 is performed, for example, by anodic bonding. Thus, it is possible to firmly bond the substrate 10 and the silicon substrate 4.

As illustrated in FIG. 2, after the silicon substrate 4 is thinned by grinding by, for example, a grinding machine, the silicon substrate 4 is patterned into a predetermined shape, and the functional element 102 is formed. Patterning is performed by photolithography and etching (dry etching), and as specific etching, it is possible to use a Bosch method.

It is possible to form the functional element 102 having the first vibrating body 40a, the second vibrating body 40b, and the connection spring 60 by the step described above.

Next, the functional element 102 having the first vibrating body 40a, the second vibrating body 40b, and the connection spring 60 is accommodated in the cavity 2 formed by the substrate 10 and the lid 20 by bonding the substrate 10 and the lid 20 (S2). Bonding between the substrate 10 and the lid 20 is performed, for example, by anodic bonding. Thus, it is possible to firmly bond the substrate 10 and the lid 20.

It is possible to manufacture the gyro sensor 100 by the steps described above.

### 1.3. Experimental Example

Hereinafter, an experimental example is illustrated and the invention is described in further detail. Moreover, the invention is not in any way limited to the following experimental example.

First, in the experimental example, simulation was performed in the gyro sensor which includes two vibrating bodies, the suspension springs supporting each vibrating body, and the connection spring connecting two vibrating bodies, and detects the angular velocity ωz about the Z axis. Specifically, the simulation was performed in the gyro sensor by a finite element method, and the natural frequency of the opposite phase mode and the natural frequency of the in-phase mode were obtained.

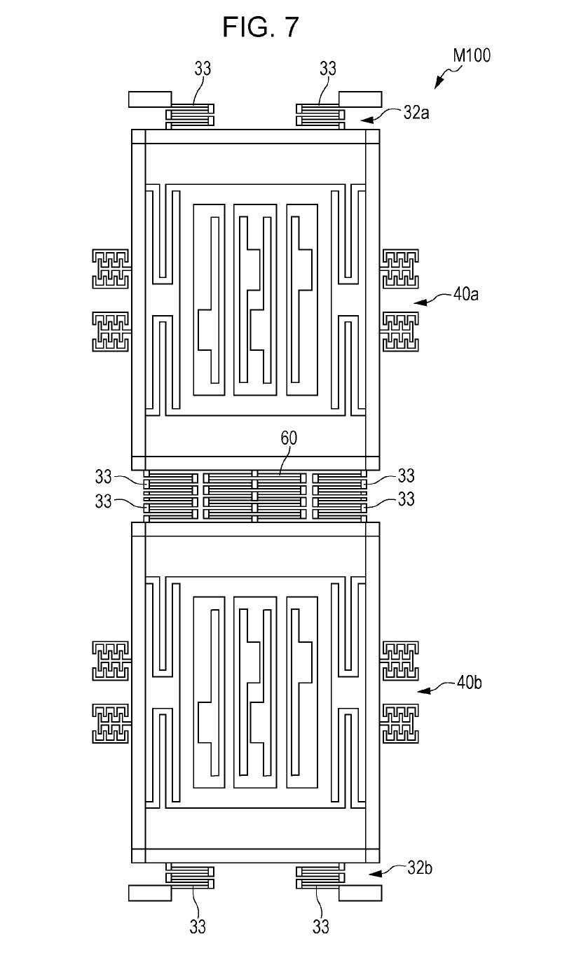

FIG. 7 is a view illustrating a gyro sensor M100 according to the example that is a model of the simulation. Moreover, in FIG. 7, in the gyro sensor M100 according to the example, the same reference numerals are given to portions corresponding to the gyro sensor 100 illustrated in FIG. 1.

As illustrated in FIG. 7, the gyro sensor M100 includes two vibrating bodies 40a and 40b, first suspension springs 32a supporting a first vibrating body 40a, second suspension springs 32b supporting a second vibrating body 40b, and a connection spring 60 connecting the two vibrating bodies 40a and 40b. The suspension springs 32a and 32b respectively support the vibrating bodies 40a and 40b by four beam sections 33. The connection spring 60 contributing to vibration of one vibrating body corresponds to two beam sections 33 (two units). That is, when a spring constant of the beam section 33 is k1, a spring constant of the suspension spring 32a contributing to the vibration of one vibrating body is 4×k1 and a spring constant of the connection spring 60 is 2×k1. A spring constant K1 of the suspension springs 32a and 32b and the spring constant K2 of the connection spring 60 satisfy 2K2<K1. That is, the connection spring 60 is softer than the suspension springs 32a and 32b.

Furthermore, as a comparison example, a gyro sensor, which is obtained by connecting a beam section of a suspension spring supporting a first vibrating body and a beam section of a suspension spring supporting a second vibrating body through a connection mass body without having a connection spring, was used.

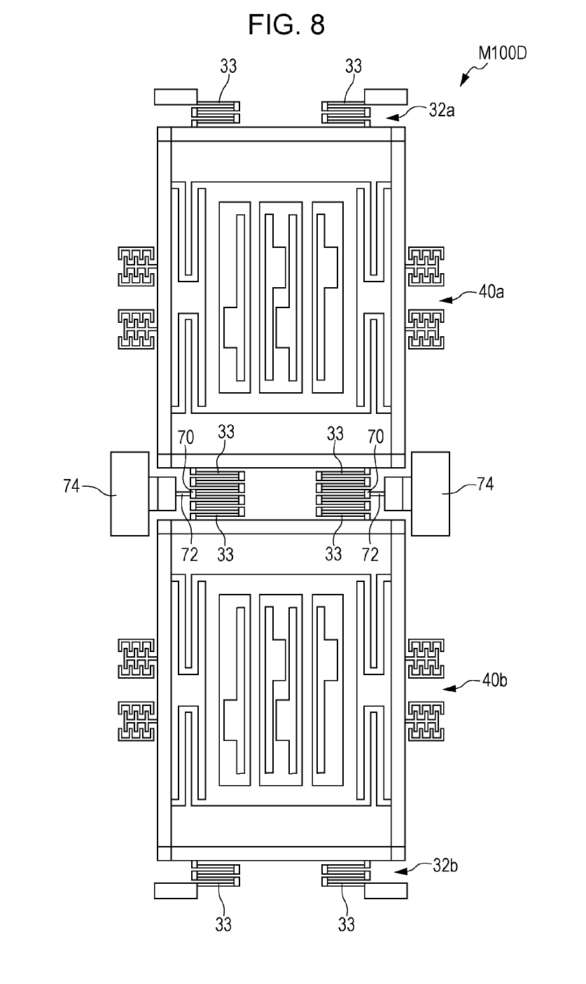

FIG. 8 is a view illustrating a gyro sensor M100D according to a comparison example that is a model of the simulation. Moreover, in FIG. 8, in the gyro sensor M100D according to the comparison example, the same reference numerals are given to portions corresponding to the gyro sensor 100 illustrated in FIG. 1.

In the gyro sensor M100D according to the comparison example, two vibrating bodies 40a and 40b are connected by connecting beam sections 33 of a first suspension spring 32a of a first vibrating body 40a and beam sections 33 of a second suspension spring 32b of the second vibrating body 40b with a connection mass body 70. The connection mass body 70 is connected to a support body (fixed section) 74 by using suspension springs 72. One end of the beam section 33 for connecting the vibrating bodies 40a and 40b is connected to the vibrating body 40a (or the vibrating body 40b) and the other end is connected to the connection mass body 70.

The suspension springs 32a and 32b respectively support the vibrating bodies 40a and 40b by two beam sections 33. As described above, in the comparison example, the first vibrating body 40a and the second vibrating body 40b are connected by the connection mass body 70 and the beam sections 33. That is, it is a structure that does not have the connection spring 60 that is provided in the embodiment.

In the gyro sensor M100, a length of one beam section 33 is L=71 and in the gyro sensor M100D, a length of one beam section 33 is L=62, and then the frequency of the drive vibration (opposite phase mode) was adjusted to be the same extent. Other structures of the gyro sensor M100D according to the comparison example are the same as the structures of the gyro sensor M100.

The simulation was performed by the finite element method.

Thus, as a result of performing the simulation, in the gyro sensor M100 according to the example, the natural frequency of the opposite phase mode was 22.05 KHz and the natural frequency of the in-phase mode was 17.94 KHz. Thus, in the gyro sensor M100 according to the example, a difference between the natural frequency of the opposite phase mode and the natural frequency of the in-phase mode was Δf=4.11 KHz.

On the other hand, in the gyro sensor M100D according to the comparison example, the natural frequency of the opposite phase mode was 22.12 KHz and the natural frequency of the in-phase mode was 19.36 KHz. Thus, in the gyro sensor M100D according to the comparison example, a difference between the natural frequency of the opposite phase mode and the natural frequency of the in-phase mode was Δf=2.76 KHz.

As a result, in the gyro sensor M100 according to the example, it was found that it is possible to separate the natural frequency of the opposite phase mode and the natural frequency of the in-phase mode compared to the gyro sensor M100D according to the comparison example.

### 2. Second Embodiment

### 2.1. Gyro Sensor

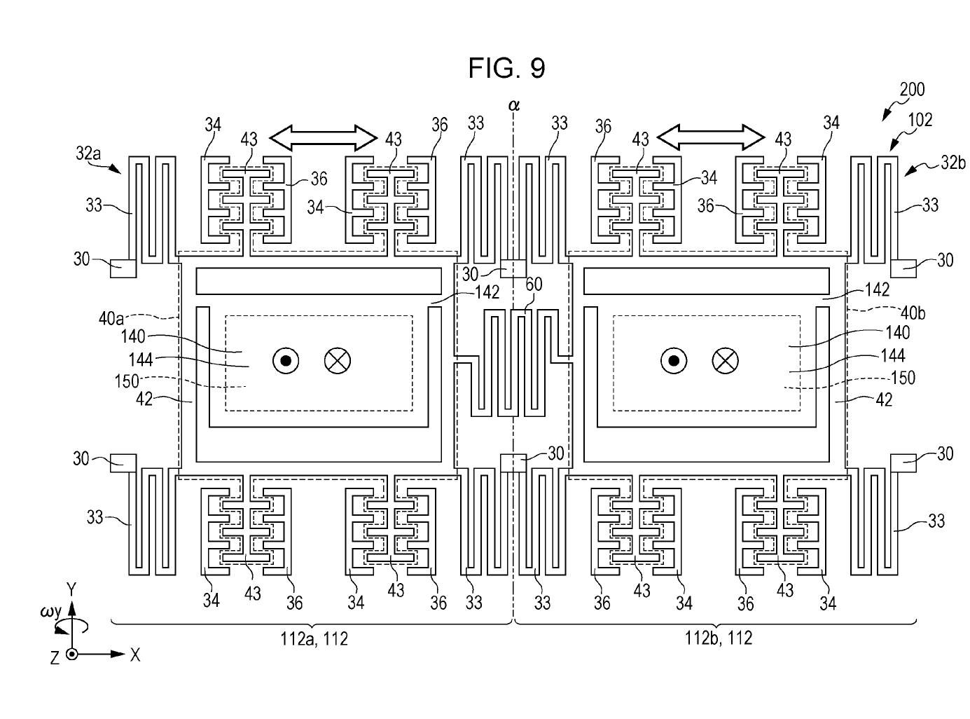

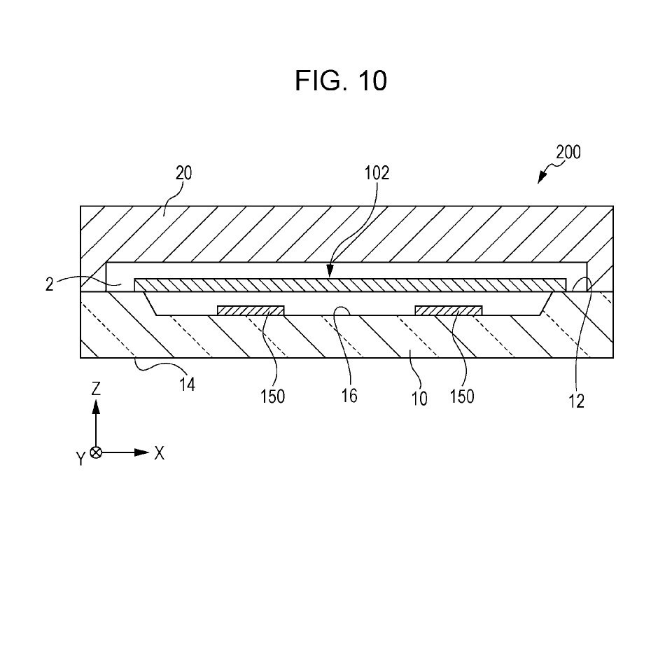

Next, a gyro sensor according to a second embodiment will be described with reference to the drawings. FIG. 9 is a plan view schematically illustrating a gyro sensor 200 according to the second embodiment. FIG. 10 is a sectional view schematically illustrating the gyro sensor 200 according to the second embodiment. Moreover, for the sake of convenience, in FIG. 9, a substrate 10 and a lid 20 are omitted. In addition, in FIG. 10, a functional element 102 is simplified. In addition, in FIGS. 9 and 10, as three axes orthogonal to each other, an X axis, a Y axis, and a Z axis are illustrated.

Hereinafter, in the gyro sensor 200 according to the second embodiment, the same reference numerals are given to members having the same functions as the structure members of the gyro sensor 100 according to the first embodiment and detailed description thereof will be omitted.

As illustrated in FIGS. 1 and 2, the gyro sensor 100 is a gyro sensor that detects the angular velocity ωz about the Z axis. On the other hand, as illustrated in FIGS. 9 and 10, the gyro sensor 200 is a gyro sensor that detects an angular velocity ωy about the Y axis.

As illustrated in FIGS. 9 and 10, the gyro sensor 200 includes a substrate 10, a lid 20, and a functional element 102. The functional element 102 includes a first structure 112a, a second structure 112b, and a connection spring 60.

The first structure 112a has fixed sections 30, first suspension springs 32a, fixed driving electrode sections 34 and 36, a first vibrating body 40a, and a fixed detection electrode section 150.

The first vibrating body 40a has a vibration section 42, movable driving electrode sections 43, a movable section 140, a beam section 142, and a movable detection electrode section 144.

The movable section 140 is supported by the vibration section 42 through the beam section 142 that is a rotary shaft. The movable section 140 is provided on an inside of the frame-shaped vibration section 42 in plan view. The movable section 140 has a plate shape.

The beam section (torsion spring) 142 is provided in a position deviated from a center of gravity of the movable section 140. In the illustrated example, the beam section 142 is provided along the X axis. The beam section 142 may be torsionally deformed. It is possible to rotate the movable section 140 about the rotary shaft that is defined by the beam section 142 by torsional deformation of the beam section 142. Thus, it is possible to displace the movable section 140 in the Z axis direction.

The movable detection electrode section 144 is provided in the movable section 140. The movable detection electrode section 144 is a portion overlapping the fixed detection electrode section 150 in the movable section 140 in plan view. An electrostatic capacity can be formed between the movable detection electrode section 144 and the fixed detection electrode section 150.

The fixed detection electrode section 150 is fixed to the substrate 10 and is provided to face the movable detection electrode section 144. The fixed detection electrode section 150 is provided on a bottom surface of a concave section 16. In the illustrated example, a planar shape of the fixed detection electrode section 150 is rectangular.

The second structure 112b has fixed sections 30, second suspension springs 32b, fixed driving electrode sections 34 and 36, a second vibrating body 40b, and a fixed detection electrode section 150.

In the second structure 112b, structures of the fixed sections 30, the second suspension springs 32b, the fixed driving electrode sections 34 and 36, and the fixed detection electrode section 150 are respectively similar to the structures of the fixed sections 30, the first suspension springs 32a, the fixed driving electrode sections 34 and 36, and the fixed detection electrode section 50 of the first structure 112a. Furthermore, a structure of the second vibrating body 40b of the second structure 112b is similar to the first vibrating body 40a of the first structure 112a and the description thereof will be omitted.

The fixed sections 30, the suspension springs 32a and 32b, the vibrating bodies 40a and 40b, and the connection spring 60 are integrally provided. For example, materials of the fixed sections 30, the suspension springs 32a and 32b, the vibrating bodies 40a and 40b, and the connection spring 60 are formed of silicon to which conductivity is given by doping the silicon impurities such as phosphorus and boron.

For example, a material of the fixed detection electrode section 150 is aluminum, gold, and ITO. It is possible to easily visually recognize foreign matters and the like that are present on the fixed detection electrode section 150 from the second surface 14 side of the substrate 10 by using a transparent electrode material such as ITO as the fixed detection electrode section 150.

A model of a mechanical structure of the gyro sensor 200 is similar to the model of the mechanical structure of the gyro sensor 100 illustrated in FIG. 3 described above. That is, in the gyro sensor 200, when a spring constant of the first suspension spring 32a supporting the first vibrating body 40a and the spring constant of the second suspension spring 32b supporting the second vibrating body 40b are K1 and a spring constant of the connection spring 60 is K2, 2K2≦K1 is satisfied. That is, the connection spring 60 is softer than the suspension springs 32a and 32b or has the same stiffness as the suspension springs 32a and 32b in the X axis direction.

Next, an operation of the gyro sensor 200 will be described below.

In a state where the first vibrating body 40a and the second vibrating body 40b perform the vibration in the X axis direction in opposite phase to each other, if the angular velocity ωy about the Y axis is applied to the gyro sensor 200, a Coriolis force is generated and the movable section 140 of the first vibrating body 40a and the movable section 140 of the second vibrating body 40b are displaced in the opposite direction to each other in the Z axis direction (along the Z axis). The movable section 140 repeats the operation during receiving the Coriolis force.

The movable section 140 is displaced in the Z axis direction and then a distance between the movable detection electrode section 144 and the fixed detection electrode section 150 is changed. Thus, an electrostatic capacity between the movable detection electrode section 144 and the fixed detection electrode section 150 is changed. It is possible to obtain the angular velocity ωy about the Y axis by detecting the change in the amount of the electrostatic capacity between the electrode sections 144 and 150.

According to the gyro sensor 200, it is possible to achieve the same operational effects as those of the gyro sensor 100.

Here, since the movable section 140 has a flap plate structure that is displaced in the Z axis direction (vertical direction), the gyro sensor detecting the angular velocity ωy about the Y axis is likely to receive the influence of the quadrature compared to the gyro sensor detecting the angular velocity ωz about the Z axis. However, according to the gyro sensor 200, it is possible to reduce the influence of the quadrature also in the gyro sensor detecting the angular velocity ωy about the Y axis.

Moreover, in the above description, a case where the gyro sensor 200 is the gyro sensor capable of detecting the angular velocity ωy about the Y axis is described, but the gyro sensor according to the invention may be a gyro sensor capable of detecting an angular velocity (fix about the X axis.

Furthermore, as illustrated in FIG. 9, in the gyro sensor 200 described above, the vibration section 42 and the movable section 140 are connected by the beam section (torsion spring) 142 and the movable section 140 is configured such that the movable section 140 is displaced in the Z axis direction by rotating about the rotary shaft that is defined by the beam section 142 according to the angular velocity ωy about the Y axis. However, the gyro sensor according to the invention is not limited to the structure.

For example, in the gyro sensor according to the invention, the beam section 142 supporting the vibration section 42 and the movable section 140 is made to be a spring structure having a meandering shape similar to the beam sections 33 or the connection spring 60 and the movable section 140 may be configured to be displaced in the Z axis direction while keeping a lower surface of the movable section 140 (movable detection electrode section 144) parallel to an upper surface of the fixed detection electrode section 150 according to the angular velocity ωy about the Y axis. Thus, it is possible to increase displacement of the electrostatic capacity between the movable detection electrode section 144 and the fixed detection electrode section 150 compared to a case where the movable section 140 performs a rotary motion.

### 2.2. Manufacturing Method of Gyro Sensor

A manufacturing method of the gyro sensor 200 according to the second embodiment will be described with reference to the drawing. As illustrated in FIG. 10, the manufacturing method of the gyro sensor 200 according to the second embodiment is basically same as the manufacturing method of the gyro sensor 100 according to the first embodiment except that a film is formed and patterned in a bottom surface of a concave section 16, for example, by a sputtering method or a chemical vapor deposition (CVD) method, and then the fixed detection electrode section 150 is formed. Thus, detailed description will be omitted.

### 2.3. Experimental Example

Hereinafter, an experimental example is illustrated and the invention is described in further detail. Moreover, the invention is not in any way limited to the following experimental example.

First, in the experimental example, simulation was performed in the gyro sensor which includes two vibrating bodies, the suspension springs supporting each vibrating body, and the connection spring connecting two vibrating bodies, and detects the angular velocity ωy about the Y axis. Specifically, the simulation was performed in the gyro sensor by a finite element method, and the natural frequency of the opposite phase mode and the natural frequency of the in-phase mode were obtained.

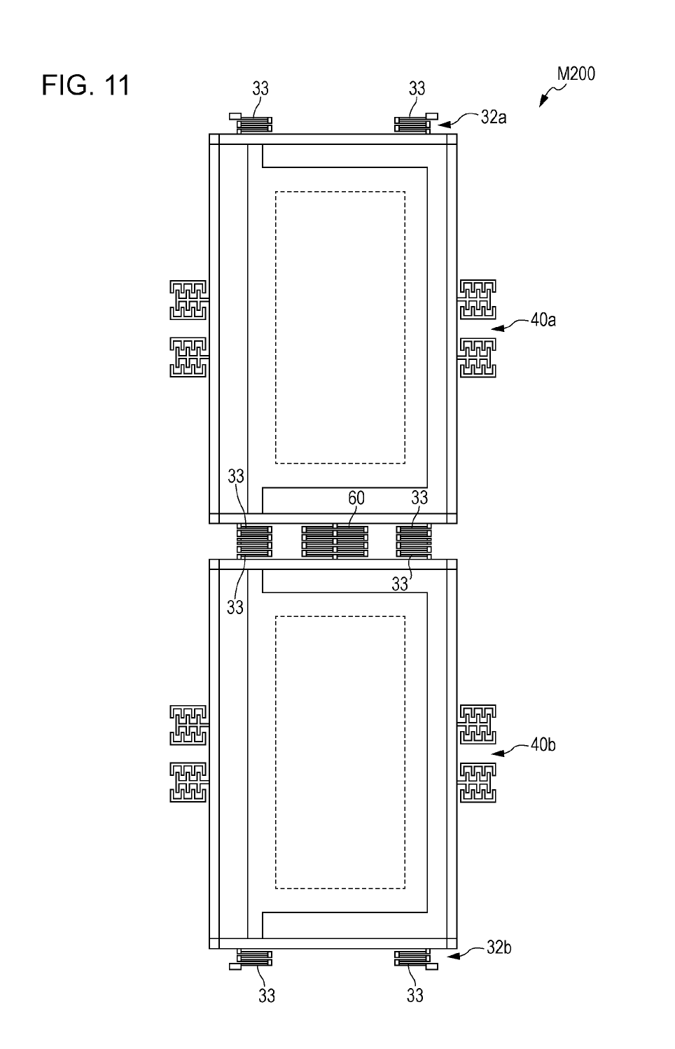

FIG. 11 is a view illustrating a gyro sensor M200 according to the example that is a model of the simulation. Moreover, in FIG. 11, in the gyro sensor M200 according to the example, the same reference numerals are given to portions corresponding to the gyro sensor 200 illustrated in FIG. 9.

As illustrated in FIG. 11, the gyro sensor M200 includes two vibrating bodies 40a and 40b, first suspension springs 32a supporting a first vibrating body 40a, second suspension springs 32b supporting a second vibrating body 40b, and a connection spring 60 connecting the two vibrating bodies 40a and 40b. The suspension springs 32a and 32b respectively support the vibrating bodies 40a and 40b by four beam sections 33. Furthermore, the connection spring contributing to vibration of one vibrating body corresponds to two beam sections 33 (two units). That is, when a spring constant of the beam section 33 is k1, a spring constant of the suspension springs 32a and 32b contributing to the vibration of one vibrating body is 4×k1 and a spring constant of the connection spring 60 is 2×k1. A spring constant K1 of the suspension springs 32a and 32b and the spring constant K2 of the connection spring 60 satisfy 2K2<K1. That is, the connection spring 60 is softer than the suspension springs 32a and 32b.

Furthermore, as a comparison example, a gyro sensor, which is obtained by connecting a beam section of a suspension spring supporting a first vibrating body and a beam section of a suspension spring supporting a second vibrating body through a connection mass body without having a connection spring, was used.

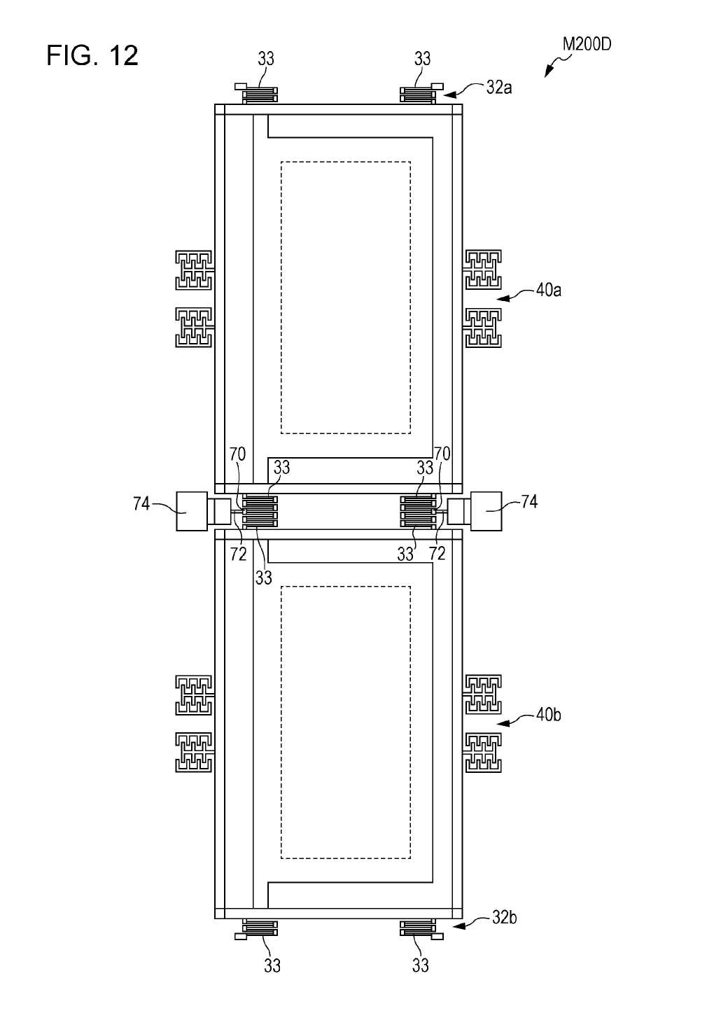

FIG. 12 is a view illustrating a gyro sensor M200D according to a comparison example that is a model of the simulation. Moreover, in FIG. 12, in the gyro sensor M200D according to the comparison example, the same reference numerals are given to portions corresponding to the gyro sensor 200 illustrated in FIG. 9.

In the gyro sensor M200D according to the comparison example, two vibrating bodies 40a and 40b are connected by connecting beam sections 33 of a first suspension spring 32a of a first vibrating body 40a and beam sections 33 of a second suspension spring 32b of a second vibrating body 40b with a connection mass body 70. The connection mass body 70 is connected to a support body (fixed section) 74 by using suspension springs 72. One end of the beam section 33 for connecting the vibrating bodies 40a and 40b is connected to the vibrating body 40a (or the vibrating body 40b) and the other end is connected to the connection mass body 70. The suspension springs 32a and 32b respectively support the vibrating bodies 40a and 40b by four beam sections 33. As described above, in the comparison example, the first vibrating body 40a and the second vibrating body 40b are connected by the connection mass body 70 and the beam sections 33. That is, it is a structure that does not have the connection spring 60 that is provided in the embodiment.

In the gyro sensor M200, a length of one beam section 33 is L=56 and in the gyro sensor M200D, a length of one beam section 33 is L=49, and then the frequency of the drive vibration (opposite phase mode) was adjusted to be the same extent. Other structures of the gyro sensor M200D according to the comparison example are the same as the structures of the gyro sensor M200.

The simulation was performed by the finite element method.

Thus, as a result of performing the simulation, in the gyro sensor M200 according to the example, the natural frequency of the opposite phase mode was 16.25 KHz and the natural frequency of the in-phase mode was 13.24 KHz. Thus, in the gyro sensor M200 according to the example, a difference between the natural frequency of the opposite phase mode and the natural frequency of the in-phase mode was Δf=3.01 KHz.

On the other hand, in the gyro sensor M200D according to the comparison example, the natural frequency of the opposite phase mode was 16.09 KHz and the natural frequency of the in-phase mode was 13.84 KHz. Thus, in the gyro sensor M200D according to the comparison example, a difference between the natural frequency of the opposite phase mode and the natural frequency of the in-phase mode was Δf=2.25 KHz.

As a result, in the gyro sensor M200 according to the example, it was found that it is possible to separate the natural frequency of the opposite phase mode and the natural frequency of the in-phase mode compared to the gyro sensor M200D according to the comparison example.

### 3. Third Embodiment

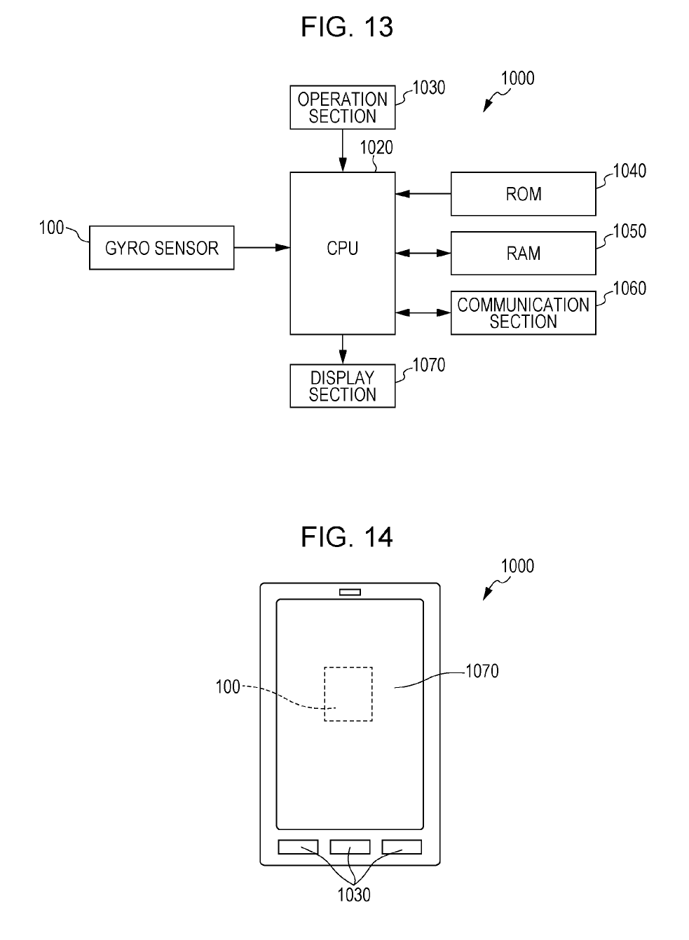

Next, an electronic apparatus according to a third embodiment will be described with reference to the drawings. FIG. 13 is a block diagram illustrating a function of an electronic apparatus 1000 according to the third embodiment.

The electronic apparatus 1000 includes the gyro sensor according to the invention. Hereinafter, a case where the gyro sensor 100 is provided as the gyro sensor according to the invention will be described.

The electronic apparatus 1000 is configured to further include a central processing unit (CPU) 1020, an operation section 1030, a read only memory (ROM) 1040, a random access memory (RAM) 1050, a communication section 1060, and a display section 1070. Moreover, the electronic apparatus according to the embodiment may be configured by omitting or changing a part of the structure elements (each section) of FIG. 13 or adding other structure elements thereto.

The gyro sensor 100 detects an angular velocity and outputs a detection signal including information of the detected angular velocity to the CPU 1020.

The CPU 1020 performs various calculation processes or control processes according to programs stored in the ROM 1040 and the like. The CPU 1020 performs various processes according to detection signals input from the gyro sensor 100. Furthermore, the CPU 1020 performs various processes according to operation signals from the operation section 1030, a process of controlling the communication section 1060 for performing data communication with an external device, a process of transmitting a display signal for displaying various types of information to the display section 1070, and the like.

The operation section 1030 is an input device that is configured of operation keys, button switches, and the like, and outputs an operation signal according to an operation performed by a user to the CPU 1020.

The ROM 1040 stores programs, data, and the like for allowing the CPU 1020 to perform various calculating processes and controlling processes.

The RAM 1050 is used for a working region of the CPU 1020 and temporarily stores programs and data that are read from the ROM 1040, data input from the gyro sensor 100, data input from the operation section 1030, calculation results that are performed by the CPU 1020 according to various programs, and the like.

The communication section 1060 performs various types of control for satisfying data communication between the CPU 1020 and the external device.

The display section 1070 is a display device that is configured of a liquid crystal display (LCD) and the like, and displays various types of information based on display signals input from the CPU 1020. A touch panel functioning as the operation section 1030 may be provided in the display section 1070.

Various electronic apparatuses may be considered as the electronic apparatus 1000, for example, a personal computer (for example, a mobile personal computer, a laptop personal computer, and a tablet personal computer), mobile terminals such as a smart phone and a mobile phone, a digital still camera, an ink jet discharge apparatus (for example, an ink-jet printer), a storage area network equipment such as a router and a switch, local area network equipment, mobile terminal base station equipment, a television, a video camera, a video recorder, a car navigation device, a real-time clock device, a pager, an electronic organizer (including communication function), an electronic dictionary, a calculator, an electronic game machine, a game controller, a word processor, a workstation, a videophone, a security television monitor, electronic binoculars, a POS terminal, a medical device (for example, an electronic thermometer, a blood pressure meter, a blood sugar meter, an electrocardiogram measuring device, an ultrasonic diagnostic device, and an electronic endoscope), a fish finder, various types of measurement equipment, instruments (for example, instruments of a vehicle, an aircraft, and a ship), a flight simulator, a head-mounted display, motion trace, motion tracking, a motion controller, a walker's position orientation measurement (PDR), and the like are exemplified.

FIG. 14 is a view illustrating an example of an appearance of a smart phone that is an example of the electronic apparatus 1000. The smart phone that is the electronic apparatus 1000 includes buttons as the operation section 1030 and a LCD as the display section 1070. The smart phone that is the electronic apparatus 1000 uses the gyro sensor 100, for example, to detect the rotation of a body of the smart phone.

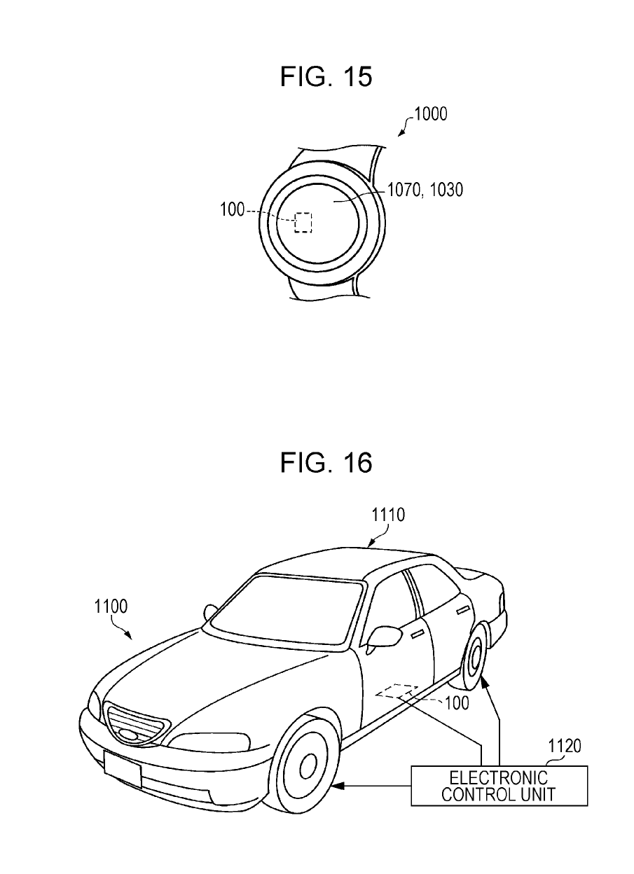

FIG. 15 is a view illustrating an example of an appearance of a wristwatch-type wearable apparatus that is an example of the electronic apparatus 1000. The wearable apparatus that is the electronic apparatus 1000 includes the LCD as the display section 1070. A touch panel functioning as the operation section 1030 may be provided in the display section 1070. The wearable apparatus that is the electronic apparatus 1000 uses the gyro sensor 100, for example, to obtain information of movement of a body of the user.

Furthermore, the wearable apparatus that is the electronic apparatus 1000 includes a position sensor such as a Global Positioning System (GPS) receiver and the like, and may measure a moving distance and a moving locus of the user.

### 4. Fourth Embodiment

Next, a moving body according to a fourth embodiment will be described with reference to the drawing. The moving body according to the fourth embodiment includes the gyro sensor according to the invention. Hereinafter, the moving body including the gyro sensor 100 as the gyro sensor according to the invention will be described.

FIG. 16 is a perspective view schematically illustrating an automobile 1100 as the moving body according to the fourth embodiment. The automobile 1100 has the built-in gyro sensor 100. As illustrated in FIG. 16, an electronic control unit (ECU) 1120 that controls an output of an engine with the built-in gyro sensor 100 detecting an angular velocity of the automobile 1100 is mounted on a vehicle body 1110 of the automobile 1100. Furthermore, in addition, the gyro sensor 100 can be widely applied to a body attitude control unit, an anti-lock braking system (ABS), an airbag, a tire pressure monitoring system (TPMS), and the like.

The invention is not limited to the embodiments described above and various modifications may be provided within the scope of the invention.

For example, the gyro sensor 100 that detects the angular velocity ωz about the Z axis is described in the first embodiment, the gyro sensor 200 that detects the angular velocity ωy about the Y axis, and the gyro sensor that detects the angular velocity ωx about the X axis are described in the second embodiment, but a gyro sensor module, in which the gyro sensors according to the invention are modularized and the angular velocities about the X axis, the Y axis, and the Z axis can be detected, may be used. Furthermore, in addition, an inertial sensor module, in which the gyro sensor for each axis including the gyro sensor according to the invention and an acceleration sensor for each axis are modularized, and the angular velocity and the acceleration of three axes (X axis, Y axis, and Z axis) can be detected, may be used.

The invention includes the substantially same structure (for example, the same structure in function, method, and result, or the same structure in object and effect) as the structure described in the embodiments. Furthermore, the invention includes structures that replace non-essential portions of the structures described in the embodiments. Furthermore, the invention includes structures that can obtain the same operational effect or the structure that can achieve the same object as the structures described in the embodiments. Furthermore, the invention includes structures obtained by adding known techniques to the structures described in the embodiments.

The entire disclosure of Japanese Patent Application No. 2014-237405, filed Nov. 25, 2014 is expressly incorporated by reference herein.

What is claimed is:

1. A gyro sensor comprising:
a substrate;
a first vibrating body and a second vibrating body;
first suspension springs that support the first vibrating body;
second suspension springs that support the second vibrating body; and
a connection spring that connects the first vibrating body and the second vibrating body,
wherein when a spring constant of the first suspension springs and the second suspension springs is K1 and a spring constant of the connection spring is K2,
2K2≦K1 is satisfied.

2. The gyro sensor according to claim 1,
wherein the first suspension springs support the first vibrating body at four points,
wherein the second suspension springs support the second vibrating body at four points, and
wherein the first suspension springs and the second suspension springs are independent.

3. The gyro sensor according to claim 1,
wherein one end of the connection spring is connected to the first vibrating body, and
wherein the other end of the connection spring is connected to the second vibrating body.

4. The gyro sensor according to claim 1,
wherein the first vibrating body and the second vibrating body are driven to vibrate in opposite phase to each other.

5. The gyro sensor according to claim 1,
wherein the spring constant K1 of the first suspension springs and the second suspension springs, and the spring constant K2 of the connection spring are the spring constants in a direction of drive vibration of the first vibrating body and the second vibrating body.

6. An electronic apparatus comprising:
the gyro sensor according to claim 1.

7. A moving body comprising:
the gyro sensor according to claim 1.
